(19) United States
(12) Patent Application Publication
(10) Pub. No.: US 2012/0119529 A1
(43) Pub. Date: May 17, 2012

(54) ROTATING POST OBSTRUCT STRUCTURE FOR BEARING BLOCK

(76) Inventor: Gordon CHIH, Lu-Kang Chen (TW)

(21) Appl. No.: 13/293,291

(22) Filed: Nov. 10, 2011

(30) Foreign Application Priority Data
Nov. 15, 2010 (TW) 099222089

(51) Int. Cl. B66D 3/04

(52) U.S. Cl. 294/82.15

(57) ABSTRACT

A rotating post obstruct structure for bearing block includes a bearing block, a connection head, a rotating post and a manually rotatable block. The connection head is disposed on the bearing block. The manually rotatable block has a longitudinal axis. The rotating post is rotatable in the connection head about the longitudinal axis. The rotating post has at least one plane face. The manually rotatable block is pivotally connected with the connection head. The manually rotatable block has a radially outward extending bulge section having an outer circumference formed with an arcuate face. The manually rotatable block can be rotated to make the outer circumference of the bulge section abut against the plane face of the rotating post to prevent rotation thereof or to make the outer circumference of the bulge section leave the plane face of the rotating post to allow rotation thereof.

### BACKGROUND OF THE INVENTION

1. Field of the Invention

The present invention relates generally to a bearing block structure, and more particularly to a rotating post obstruct structure for bearing block.

2. Description of the Related Art

A conventional bearing block applied to a sailboat includes a sheave and a shackle. The sheave serves to receive a cable. The shackle is used to support the mast, boom or deck of the sailboat. In demand of sailing control, the sheave sometimes needs to be rotated relative to the shackle and sometimes must be prevented from rotating. Therefore, it is necessary to provide a switch mechanism for switching the bearing block between a locked mode and an unlocked mode.

For example, U.S. Pat. No. 5,984,278 discloses a swivel post latch system for a bearing block. The system includes a bearing block having a sheave, a swivel post, a shackle connected to the swivel post, and a latch mechanism. The swivel post has a recess or an opening. The latch mechanism is movable into engagement with the recess or the opening to prevent rotation of the swivel post or out of engagement with the recess or the opening to allow rotation of the swivel post.

The above structure has some shorcomings as follows:

(1) The latch mechanism must be precisely aimed at the recess or the opening to engage therewith. This is unready and inconvenient to the sailing control.

(2) The wind force applied to the sail of a sailboat is often over several hundreds of kilograms. Therefore, it is uneasy to release the latch mechanism from the sidewalls of the recess or the opening.

(3) The latch mechanism can be securely engaged in the recess or the opening. However, there is no swinging room between the sheave and the shackle. In other words, such structure can hardly provide any buffering effect.

### SUMMARY OF THE INVENTION

It is therefore a primary object of the present invention to provide a rotating post obstruct structure for bearing block, which can be readily and conveniently shifted to prevent rotation of a rotating post of the bearing block.

It is a further object of the present invention to provide the above rotating post obstruct structure for bearing block, which can be easily manually shifted to securely and truly prevent rotation of the rotating post of the bearing block.

To achieve the above and other objects, the rotating post obstruct structure for bearing block of the present invention includes a bearing block, a connection head, a rotating post and a manually rotatable block. The connection head is disposed on the bearing block. The manually rotatable block has a longitudinal axis. The rotating post is rotatable in the connection head about the longitudinal axis. The rotating post has at least one plane face. The manually rotatable block is pivotally connected with the connection head. The manually rotatable block has a radially outward extending bulge section having an outer circumference formed with an arcuate face. The manually rotatable block can be rotated to make the outer circumference of the bulge section abut against the plane face of the rotating post to prevent rotation thereof or to make the outer circumference of the bulge section leave the plane face of the rotating post to allow rotation thereof.

The present invention can be best understood through the following description and accompanying drawings, wherein:

### BRIEF DESCRIPTION OF THE DRAWINGS

FIG. 1 is a perspective view of a preferred embodiment of the present invention;

FIG. 2 is a perspective view of the manually rotatable block of the preferred embodiment of the present invention;

FIG. 3 is a sectional view taken along line A-A of FIG. 1;

FIG. 4 is a sectional view according to FIG. 3, showing that the manually rotatable block leaves the rotating post;

FIG. 5 is a sectional view taken along line B-B of FIG. 1;

FIG. 6 is a perspective view of the rotating post of the preferred embodiment of the present invention; and

FIG. 7 is a perspective view of the rotating post of another embodiment of the present invention.

### DETAILED DESCRIPTION OF THE PREFERRED EMBODIMENTS

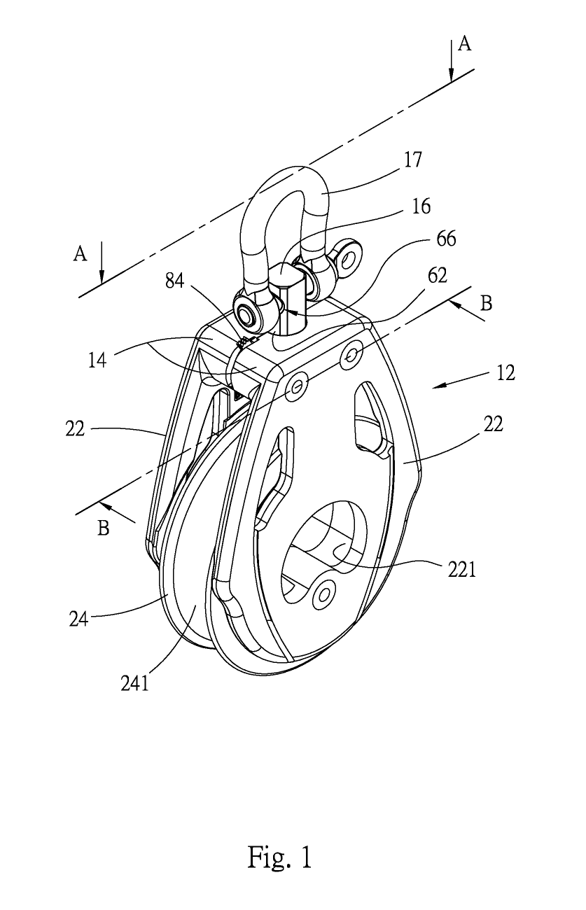

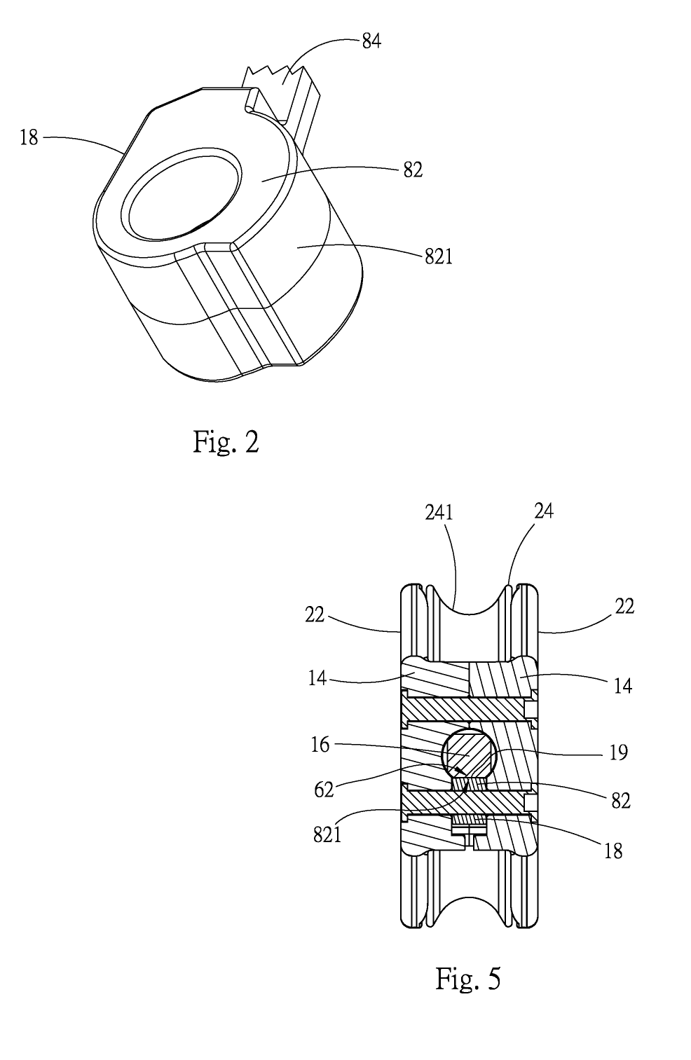

Please refer to FIGS. 1, 2, 3 and 4. According to a preferred embodiment, the rotating post obstruct structure for bearing block of the present invention includes a bearing block 12, a connection head 14, a rotating post 16 and a manually rotatable block 18.

The bearing block 12 pertains to prior art and thus will be only generally described hereinafter. The bearing block 12 includes a pair of cheeks 22 and a ring-shaped sheave 24. The cheeks 22 are spaced from each other and arranged in parallel to each other. The ring-shaped sheave 24 is rotatably disposed between the cheeks 22. A shaft 221 is defined between the cheeks 22 and the ring-shaped sheave 24 is fitted on the shaft 221. The ring-shaped sheave 24 has an outer circumference 241 formed with a groove for receiving a cable therein. A bearing 26 such as a ball bearing is disposed between the ring-shaped sheave 24 and the shaft 221 to reduce friction. The cheeks 22 are fixedly connected with each other by means of screws or rivets.

The cheeks 22 partially extend to an upper side of the ring-shaped sheave 24 to form the connection head 14.

The rotating post 16 is formed with at least one plane face 62 on outer side. The rotating post 16 has a disc-like cap section 64 at a first end, which is rotatably received in a disc-shaped cavity 42 formed in the connection head 14. The rotating post 16 has a longitudinal axis and is rotatable in the connection head 14 about the axis. The rotating post 16 has a second end formed with a transverse through hole 66 for connecting with a conventional shackle 17, which serves to support the mast, boom or deck of a sailboat.

The manually rotatable block 18 is pivotally connected with the connection head 14. The manually rotatable block 18 has a radially outward extending bulge section 82. The bulge section 82 has an outer circumference 821 formed with an arcuate face corresponding to the plane face 61 of the rotating post 16.

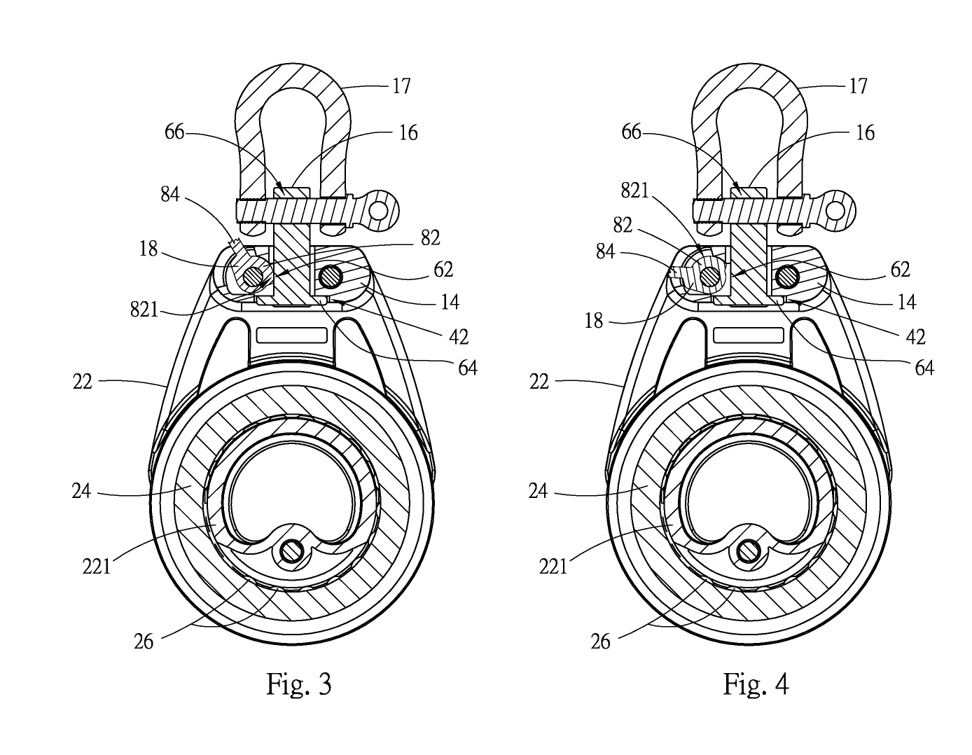

Please refer to FIGS. 3 and 4. When the manually rotatable block 18 is rotated to make the outer circumference 821 of the bulge section 82 abut against the plane face 62 of the rotating post 16, the manually rotatable block 18 hinders the rotating post 16 from rotating. On the other hand, when the manually rotatable block 18 is rotated to make the outer circumference 821 of the bulge section 82 leave the plane face 62 of the rotating post 16, the rotating post 16 is allowed to rotate.

The rotating post obstruct structure for bearing block of the present invention has the following advantages:

1. The outer circumference 821 of the bulge section 82 of the manually rotatable block 18 is formed with an arcuate face, whereby the manually rotatable block 18 can be easily manually shifted to abut against or leave the rotating post 16.

2. As shown in FIG. 5, the outer circumference 821 of the bulge section 82 of the manually rotatable block 18 is formed with an arcuate face so that the manually rotatable block 18 abuts against the plane face 62 of the rotating post 16 by a straight contact line 19. In this case, the manually rotatable block 18 can be easily manually shifted to abut against or leave the rotating post 16 to securely and truly prevent rotation thereof.

3. The manually rotatable block 18 abuts against the plane face 62 of the rotating post 16 by a straight contact line 19, whereby there is a swinging room for the bearing block 12 to provide a buffering effect.

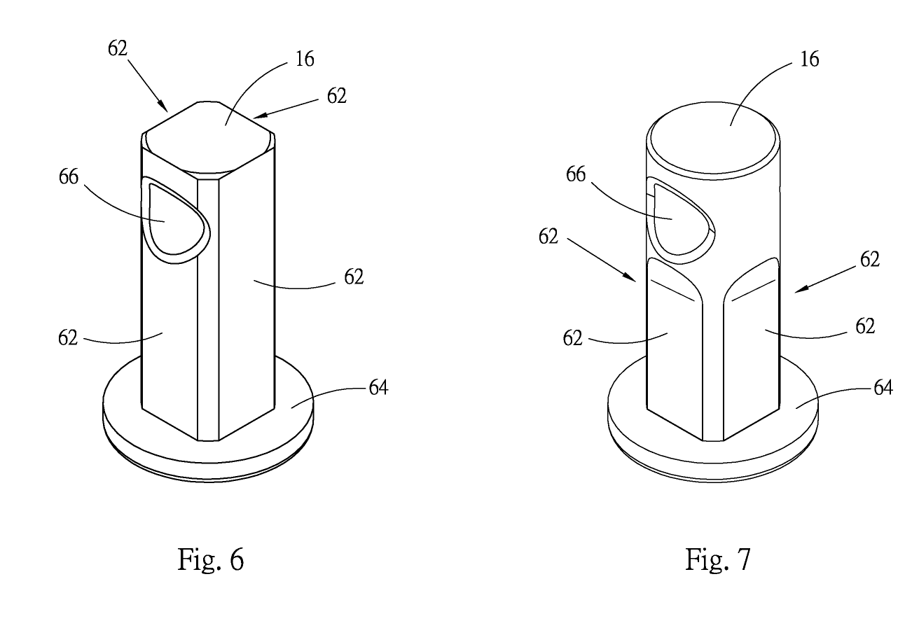

Please refer to FIGS. 6 and 7. In the rotating post obstruct structure for bearing block of the present invention, the rotating post 16 has four plane faces 62 around the longitudinal axis. The plane faces 62 extend along the longitudinal axis from inner side of the disc-like cap section 64 to the second end of the rotating post 16 or to a position near the through hole 66. Each two adjacent plane faces 62 contain a right angle, whereby the rotating post 16 can be readily locked with the manually rotatable block 18.

It should be noted that the rotating post 16 has four plane faces 62. Unless the rotating post 16 is rotated to a position where the corner contained between two adjacent plane faces is directed to the manually rotatable block 18, the manually rotatable block 18 can be easily shifted to abut against the rotating post 16. Even if the rotating post 16 is rotated to a position where the corner is directed to the manually rotatable block 18, a user only needs to slightly swing the bearing block 12 or the shackle 17 so as to immediately shift the manually rotatable block 18 to abut against the rotating post 16. This is ready and convenient to sailing of a sailboat on a sea.

In the rotating post obstruct structure for bearing block of the present invention, the rotating post 16 can alternatively have two or three plane faces 62 to achieve the same effect.

Please refer to FIGS. 1, 2, 3 and 4. In the rotating post obstruct structure for bearing block of the present invention, the manually rotatable block 18 has a fingerlike protrusion 84 radially outward extending from the manually rotatable block 18 in a direction other than that of the bulge section 82 for user to conveniently shift the manually rotatable block 18.

In the case that the rotating post 16 has four plane faces 62, one of the plane faces 62 is formed in a position corresponding to the position of the through hole 66. Accordingly, the shackle 17 can be positioned in two positions where the plane of the shackle 17 is normal to or parallel to the plane of the ring-shaped sheave 24.

What is claimed is:

1. A rotating post obstruct structure for bearing block, comprising:
a bearing block;
a connection head disposed on the bearing block;
a rotating post having a longitudinal axis, the rotating post being rotatable in the connection head about the longitudinal axis, the rotating post having at least one plane face; and
a manually rotatable block pivotally connected with the connection head, the manually rotatable block having a radially outward extending bulge section, the bulge section having an outer circumference formed with an arcuate face, whereby when the manually rotatable block is rotated, the outer circumference of the bulge section is selected from the group consisting of abutting against the plane face of the rotating post to prevent rotation thereof and leaving the plane face of the rotating post to allow rotation thereof.

2. The rotating post obstruct structure for bearing block as claimed in claim 1, wherein the rotating post has several plane faces around the longitudinal axis of the rotating post, the number of the plane faces of the rotating post being selected from the group consisting of 1, 2 and 3.

3. The rotating post obstruct structure for bearing block as claimed in claim 1, wherein the manually rotatable block has a fingerlike protrusion radially outward extending from the manually rotatable block in a direction other than that of the bulge section.

4. The rotating post obstruct structure for bearing block as claimed in claim 2, wherein the manually rotatable block has a fingerlike protrusion radially outward extending from the manually rotatable block in a direction other than that of the bulge section.
